(19) United States
(12) Patent Application Publication
(10) Pub. No.: US 2010/0170384 A1
(43) Pub. Date: Jul. 8, 2010

(54) LOCKING DEVICE

(75) Inventor: Peter Jarrett, Hertfordshire (GB)

Correspondence Address: BUCHANAN, INGERSOLL & ROONEY PC, POST OFFICE BOX 1404, ALEXANDRIA, VA, 22313-1404, US

(73) Assignee: MBDA UK Limited, Stevenage, Hertfordshire (GB)

(21) Appl. No.: 12/601,945

(22) PCT Filed: May 27, 2008
(86) PCT No.: PCT/GB08/50381

§ 371 Date: Nov. 25, 2009

(30) Foreign Application Priority Data
May 25, 2007 (EP) 07270026.3
May 25, 2007 (GB) 0709982.3

(51) Int. Cl. F15B 15/19

(52) U.S. Cl. 89/1.14

(57) ABSTRACT

A pyrotechnic releasable locking device for maintaining a first and a second member of a structure in a fixed relationship. The locking device comprises a body for locating on or within the first member of the structure such that, in use, a part of the body protrudes into the second member of the structure. The pyrotechnic compound is located on or within the body and a channel is located in the interior of the body and runs between the pyrotechnic compound and an exterior surface of the part of the body that, in use, protrudes into a recess in the second member of the structure. When the pyrotechnic compound is ignited the combustion gases travel along the channel into the recess of the second member of the structure, and the resultant gas pressure forces the body out of the recess thereby releasing the second member of the structure.

The present invention relates to locking devices and in particular mechanical locking devices. A locking device is used to prevent a part of an assembled structure from moving relative to another part of the structure.

Mechanical locking devices generally include a locking pin, detent or similar item which is located within or on one part of the structure and which protrudes into another part of the structure. When certain conditions are met and it is no longer desirable to prevent the different parts of the structure from moving relative to each other, the locking pin or detent is removed to allow those parts of the structure to move relative to one another. This may be achieved by shearing the locking pin or by causing the locking pin or detent to retract or move in some other way such that it no longer prevents relative movement of the parts of the structure.

Locking devices of this type are often found, for example, in aircraft and missiles. During launch or take-off, missiles and aircraft are subject to high aerodynamic loads and to prevent undue stressing it is often desirable to prevent various components from moving until the launch or take-off has occurred. Locking devices may be used, for example, to prevent the deployment of aerodynamic control surfaces, such as canards or fins, until these are required. Locking devices may also be used to prevent movement of gimbals in navigational equipment and in missile seekers, especially when these items are being transported prior to use and during launch/take-off. Another example of the use of locking devices is in the safety and arming units of missile fuzes, where they are routinely used to prevent premature detonation.

Mechanical locking devices may be operated in various ways, such as by using the centrifugal force of a spinning projectile to cause release of the detent, or by utilising the potential energy of a coiled spring, for example. Another known way of operating a mechanical locking device is by using a propellant compound which, when ignited, produces a gas. Such types of locking devices are often referred to as pyrotechnic locking devices. For aerospace applications in particular, pyrotechnic locking devices are desirable as they combine good reliability with a very efficient and compact way of storing energy in the form of the chemical propellant.

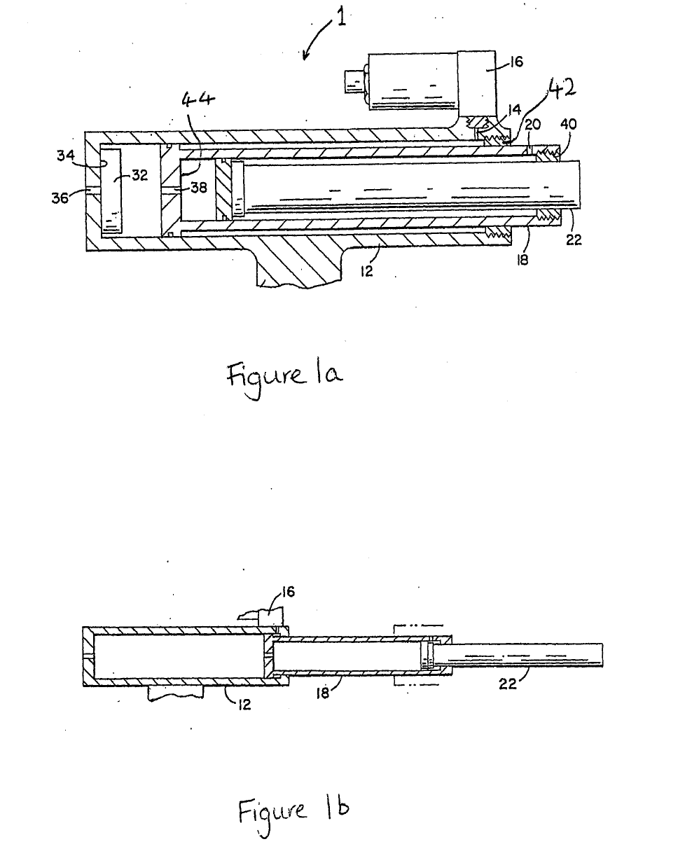

A type of known pyrotechnic locking device is described in U.S. Pat. No. 4,037,821 to Greene. This device is a telescoping pyrotechnic retractor which, when activated, causes a piston to be retracted. The piston is connected to an umbilical connector for connecting a missile to its ground support apparatus. On launch of the missile, the device is activated causing the piston to retract into its housing, thereby disconnecting the missile from its ground support apparatus. Although this prior art is concerned with detaching an umbilical connector rather than a mechanical locking pin, the principle of operation of the pyrotechnic retractor is the same and is described with reference to FIGS. 1a and 1b.

The present invention seeks to provide an improved pyrotechnic locking device over the known pyrotechnic retractors.

According to the present invention there is provided a locking device for maintaining a first member and a second member in a fixed relationship, the locking device comprising a body for locating on or within the first member such that, in use, a part of the body protrudes into the second member, a pyrotechnic compound being located on or within the body, means for igniting the pyrotechnic compound, and a channel located in the interior of the body running between the pyrotechnic compound and an exterior surface of the part of the body that, in use, protrudes into the second member.

The body may be provided with a housing, the housing being fixed to a surface of the first member. The surface may be that surface defining a recess created in the first member. Alternatively the body may be located directly within a recess created in the first member, without requiring a separate housing.

Preferably a frangible seal is provided where the channel meets the exterior surface of the body to prevent any gas or debris from entering or exiting the channel. The frangible seal is ideally designed to fracture when the pressure within the channel reaches a predetermined level.

A crumple zone may be provided on or within the body at the end remote from the second member. Alternatively a crumple zone may be provided on the base of the housing and/or on the first member.

The ignition means may comprise a power source, ignition wires and a filament. The pyrotechnic compound may be ignited remotely. More than one type of pyrotechnic compound may be provided.

The exterior surface of the body may comprise one or more graduations. Similarly the bore of the housing, if there is one, may be graduated to complement the graduations on the exterior surface of the body. Alternatively, where there is no separate housing provided, the bore of the recess in the first member may be graduated.

In accordance with the present invention there is further provided a method for releasably locking a second member to a first member, the method comprising the steps of:

providing a locking device, the locking device comprising a body, a pyrotechnic compound, means for igniting the pyrotechnic compound, and a channel located in the interior of the body running between the pyrotechnic compound and an exterior surface defining an end of the body;

locating the locking device on or within the first member;

providing a recess in the second member for receiving the end of the body;

locating the end of the body in the recess in the second member;

ensuring that a seal is created between the body and the walls which define the recess;

when desired, igniting the pyrotechnic compound thereby causing combustion gases to travel along the channel into the recess of the second member, the resultant gas pressure forcing the body out of the recess and thereby releasing the second member.

The present invention will now be described with reference to the accompanying drawings, of which:

FIGS. 1a and 1b show a known pyrotechnic locking device in the form of a pyrotechnic retractor.

FIG. 2 shows a cross-sectional view of a pyrotechnic locking device in accordance with the present invention, the locking device being in the unfired position.

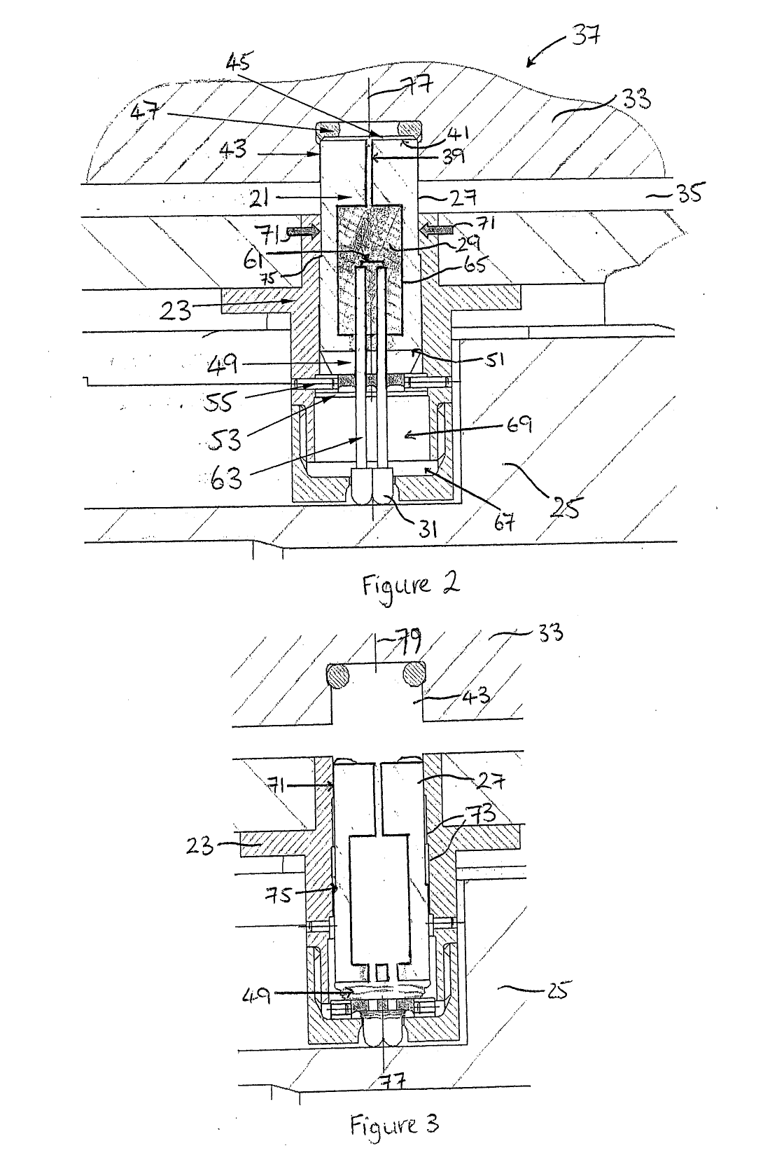

FIG. 3 shows a cross-sectional view of the pyrotechnic locking device of FIG. 2, the locking device being in the fired position.

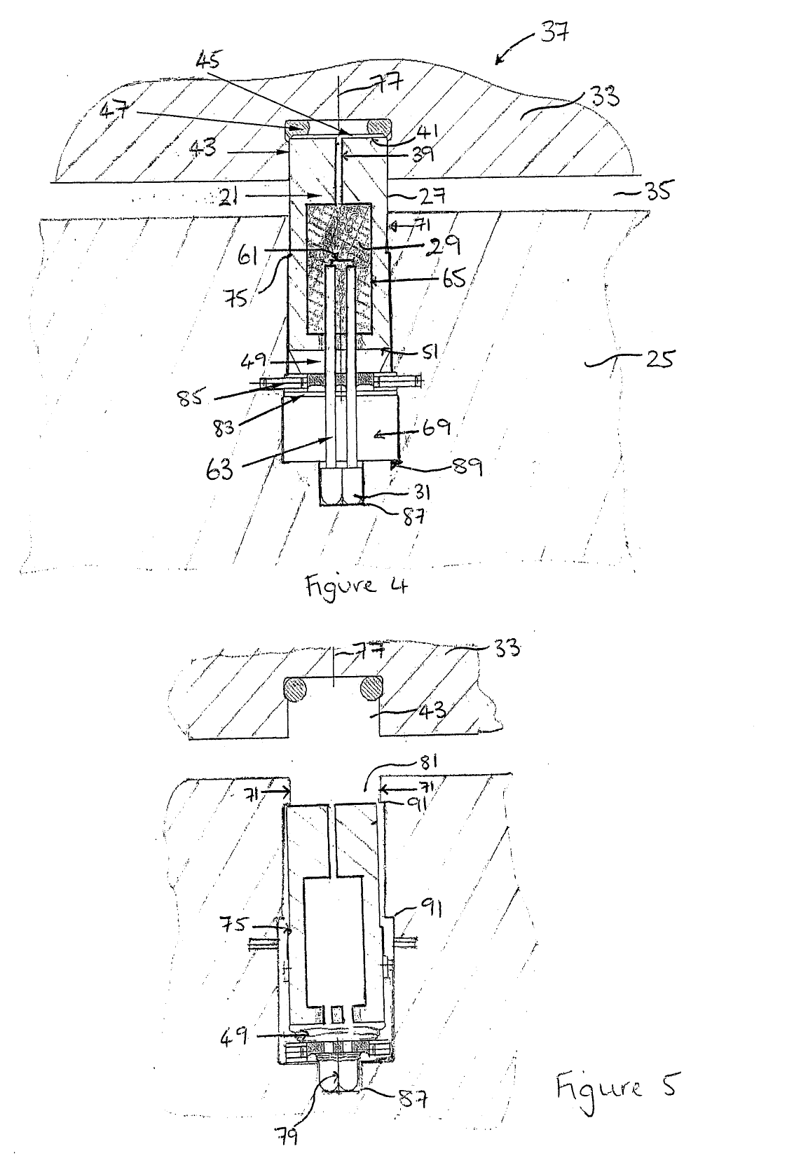

FIG. 4 shows a cross-sectional view of a different embodiment of a pyrotechnic locking device in accordance with the present invention, the locking device being in the unfired position.

FIG. 5 shows a cross-sectional view of the pyrotechnic locking device of FIG. 4, the locking device being in the fired position.

FIG. 1a shows a known pyrotechnic retractor 1 having a cylindrical housing 12. Located in the interior of the housing at the base 34 of the cylinder is a shock absorbing disk 32. A hole 36 is provided in the base 34 of the cylinder to allow air to flow between the interior of the cylindrical housing 12 and its exterior. A pyrotechnic power cartridge 16 is located on the outside of the housing 12 and an inlet port 14 is provided in the housing 12 adjacent to the power cartridge 16 to allow gases produced by the power cartridge to flow from the power cartridge 16 through the inlet port 14 into the interior of the cylindrical housing 12. A second stage cylinder 18 is located concentrically within the cylindrical housing 12 and is slidably mounted within the housing 12. The second stage cylinder 18 has an inlet port 20 for allowing gases to flow between the exterior of the cylinder 18 and its interior. The second stage cylinder 18 also has a hole 38 provided in its base 44 to allow air to flow between the interior of the cylinder 18 and its exterior. A piston 22 is slidably located within the second stage cylinder 18. The cylinders 12 and 18 are sealed by air plugs 42 and 40 respectively.

In use, the telescoping retractor 1 is fully extended as shown in FIG. 1b. The piston 22 can be thought of as a locking pin which protrudes into a first structure (not shown). The housing 12 is attached to a different structure (not shown). When it is desired that the first structure be released, the pyrotechnic retractor is activated and operates in the following way: The pyrotechnic power cartridge is remotely fired and the propellant inside burns to produce a gas. As the gas pressure in the power cartridge increases, the gas escapes along inlet port 14 into the interior of the cylindrical housing 12. The gas pressure forces cylinder 18 to retract into the housing 12. When cylinder 18 is completely retracted the inlet port 20 located in cylinder 18 is aligned with inlet port 14. This allows gas to enter the interior of cylinder 18 via the inlet port 20, which causes the piston 22 to be retracted into the cylinder 18. Once fully retracted, the device 1 is as shown in FIG. 1a and the piston 22 is no longer protruding into the first structure and locking it in position.

Turning now to the present invention, FIG. 2 shows a first structure 25 and a second structure 33 of an assembly 37. A pyrotechnic locking device 21 is present in the assembly to prevent the second structure 33 from moving relative to the first structure 25. The first and second structure may be, for example, a missile body and a missile fin respectively, the locking device being used to prevent movement of the fin relative to the body of the missile until after launch of the missile.

The pyrotechnic locking device 21 comprises a body 27. The body 27 is located in a housing 23 which is located in the first structure 25. The body 27 extends from the first structure 25 through air gap 35 and protrudes into a recess 43 located in the second structure 33. There is a chamber 65 in the interior of the body 27 which contains a pyrotechnic compound 29. The body 27 contains ignition means 31 for igniting the pyrotechnic compound 29. The body 27 also has a channel 39 located within the interior of the body 27, the channel extending from the chamber 65 containing the pyrotechnic compound 29 to the end 41 of the body 27 that is located in the recess 43 of the second structure 33. A frangible seal 45 covers the end of the channel 39 to prevent any debris from entering the channel and to prevent any gases escaping from the channel until sufficient pressure to break the seal 45 has built up in the channel.

The recess 43 of second structure 33 is designed to snugly receive the body 27. An O-ring 47 is provided to ensure a tight seal between the recess 43 and the body 27.

At the end 51 of the body that is remote from the second structure 33, the body is provided with a crumple zone 49 which is formed from a material capable of absorbing energy on impact. The crumple zone may be a corrugated aluminum skirt or cylinder attached to the bottom of the body, for example. The body 27 is supported in the housing 23 by a retaining ring 53 which is linked or attached to or formed integrally with several frangible shear links 55 which are distributed radially in the housing.

Whilst it is desired that the two structures are fixed relative to each other, during ground transit and launch of a missile, for example, the locking device 21 will remain in the position shown, preventing relative movement of the two structures of the assembly. Once it is desirable that the two structures should move freely with respect to each other, following launch of a missile, for example, then the ignition means are activated causing the compound to ignite and start to burn. The pyrotechnic compound 29 is a known propellant suitable for controlled burning, such as SR44 (boron/potassium nitrate inorganic compound) for example. The ignition means are also well known and both the pyrotechnic compound and the ignition means may be purchased from manufacturers of pyrotechnic actuators, such as Leafield Engineering Limited in the UK, for example.

In this example the means for igniting the pyrotechnic compound comprise ignition wires 63 and a filament 61, but other known means of igniting a pyrotechnic compound may be utilised instead. To activate the ignition means, a current is passed through the ignition wires and filament 61. The filament is located in contact with or immediately adjacent to the pyrotechnic compound 29. As the current passes through the filament, it causes the filament to radiate heat which is absorbed by the pyrotechnic material. The pyrotechnic material is designed to ignite upon reaching a certain temperature, and then burns in a rapid but controlled manner. Upon burning, the pyrotechnic compound rapidly produces a gas and, as the pyrotechnic compound burns, the pressure of the gas present in the chamber 65 in the interior of the body rapidly increases. The gas is able to travel up the channel 39 which leads from the chamber 65 to the frangible seal 45. When the gas pressure has reached a certain level, the frangible seal 45 will rupture allowing the gas to escape from the interior of the body 27 into the recess 43 of the second structure 33. Due to the tight fit of the body 27 in the recess 43 and the O-ring seal 47, the gas cannot escape from the recess 43. The gas pressure will continue to increase in the recess 43 until sufficient pressure exists to overcome static friction (stiction), inertia and the shear force required to break the frangible shear links 55. At this point the body 27 is rapidly ejected from the recess 43, unlocking the second structure from the first structure and thereby allowing the structures to move relative to one another.

FIG. 3 shows the locking device after it has been activated, and is now in the ‘unlock’ position. The body 27 has fully exited the recess 43 and has retracted into the housing 23 leaving no part protruding which could interfere with the aerodynamic performance of the missile 25. On being ejected from the recess 43 the body 27 travels deeper into the housing 23 into chamber 69 until it impacts with the base 67 of the housing. The kinetic energy of the body is absorbed upon impact by the crumple zone 49. This prevents damage to the structure 25. The now-redundant ignition wires 63 are crushed on impact.

The housing 23 has an interface bore 71 which is manufactured to very tight tolerances to ensure that the body 27 fits tightly within the bore 71 so that it can not easily move and so that the housing maintains alignment of the body 27. The housing also has a graduated bore 73 which complements the graduated exterior surface 75 of the body. Prior to firing, the body snugly fits into the housing and the graduations on the body 75 and housing 73 help to constrain movement of the body 27. After firing, the graduations on the body 75 and housing 73 prevent the body from exiting the housing during subsequent motion of the first structure 25. Furthermore, the tight tolerancing of the interface bore 71 acts to prevent the body from protruding from the housing into the air gap 35, as shown in FIG. 3. Additionally, after firing, the body may be pushed out of alignment as shown in FIG. 5 and the chamber 69, being of a greater diameter than the body 27, allows the body to rest out of alignment such that the longitudinal axis of the body 77 does not exactly correspond to the longitudinal axis of the housing 79. This lack of alignment of the body, in addition to the tight tolerancing of the interface bore 71, prevents the body from escaping from the housing during motion of the structure 25. This ensures that the body 27 cannot re-engage with the second structure 33 or protrude or fall from the structure 25 which may not be desirable for certain uses such as on aircraft or missiles for example. If required, further retaining means for preventing the body from escaping from the housing may be provided as a safety backup (not shown). Such further retaining means may include, for example, a sprung pin or skirt located on the body 77 which deploys upon activation of the locking device and allows the body to move in one direction (deeper into the housing) but not in the reverse direction, similar to the action of a barb.

It will of course be recognised that the graduations on the body and housing are not critical in permitting the successful application of this invention and, particularly in applications where the second structure 33 is released and moves away from its original position so that there is no risk of body 27 re-engaging with the second structure 33, it may not be necessary to provide any graduations on the body and housing. Similarly, further retaining means for preventing the body from escaping from the housing may be not required for certain applications.

It is worth noting that various modifications may be made to this design without affecting the principle of the invention. For example, the channel 39 is shown as extending along the longitudinal axis of the body 77 in FIG. 2. However, the channel may be located anywhere within the body such that it allows combustion gases to flow from the chamber containing the pyrotechnic compound to the end 41 of the body that is engaged in the second structure 33. Similarly a crumple zone 49 may be located on the base 67 of the housing instead of or in addition to being located on the body itself. If the structure 25 is robust and unlikely to be affected by the impact of the body upon it, then a crumple zone may not be needed at all. The O-ring 47 may also not be required if the tolerancing between the recess 43 of the second structure 33 and the body 27 is tight enough to create an effective seal.

The pyrotechnic compound is shown as being a simple propellant, but depending on safety considerations, the size of the body 27 and the force required to move it, and availability of suitable compounds, two or more compounds may be used. In this scenario, one of the compounds may be more readily ignited than the other, and ignition of the first compound may cause a gradual ignition of the second compound. Alternatively the compounds may be required to mix to produce a composition suitable for use as a propellant. It is again stressed that the pyrotechnic compound(s) and the means for igniting them are available as ‘off-the-shelf’ products which may be chosen in accordance with the size and required use of the locking device. In this example, the pyrotechnic explosive compound and igniter as used in Leafield Engineering Limited's Protractor 022000 were used, and a current of 5 A was passed through the filament for a minimum of 10 ms to ignite the propellant.

The locking device may be of whatever size and material strength is required to retain the two structures of the assembly in a fixed relationship to each other. In this example, it is presumed that the first structure is the body of a missile and the second structure is a missile fin. It is highly desirable to minimise weight and size of the locking device for this application as missiles are generally designed to be as small and light as possible. Similarly for aerospace applications, it is desirable to have a small, lightweight locking device to ensure that the size and weight of the aircraft does not exceed its design parameters. In this example, the body 27 is made from corrosion resistant steel, and the crumple zone is made from corrugated aluminum. The shear links 55 are designed to fracture when subjected to a force of 300N. This value is relatively arbitrary but should be chosen such that it is well within the ejection force capability of the locking device (which is over 1000N for this example) but is sufficiently high enough to prevent accidental fracturing of the shear links from any impact during handling or assembly of the missile. Depending upon the forces that the locking device is likely to be subjected to prior to firing, which in turn depends on the application for which the locking device is required, the shear links may be designed to fracture at an appropriate level of force. The pyrotechnic compound(s) and quantity of propellant material required will also depend upon the size of the body and the shear link design. This example employed four shear links located radially at 90 degree intervals and made from copper wire of 0.65 mm diameter to achieve the required 300N shear force threshold level. Clearly the number, size and material used in the shear links may be tailored for any required application.

In this example, the pyrotechnic composition is shown as being located in a chamber 65 within the interior of the body 27. Alternatively, the pyrotechnic composition may be located on an exterior chamber (not shown) which is attached to the exterior of the body 27 and travels with the body 27 as the body is ejected from the recess 43. In this case a suitable conduit for the combustion gases must be provided to ensure that the gases are able to travel from the chamber containing the pyrotechnic compound to the recess 43 of the second structure 33. Such a conduit may be provided through the interior of the body 27.

FIG. 4 shows a pyrotechnic locking device similar to that shown in

FIG. 2, except that the housing 23 has been removed and has been replaced by machining first structure 25 in a manner which provides an integral housing for the body 27. Features which are the same in both FIGS. 2 and 4 are indicated by the same reference numerals. Many of the potential modifications to the embodiment shown in FIG. 2 which are described with reference to that figure may also be applied to the embodiment shown in FIG. 4.

FIG. 4 shows the first structure 25 and the second structure 33 of the assembly 37. The second structure has the same features as those described with reference to FIG. 2. The first structure 25 has a recess 81 machined into it, the recess 81 being dimensioned to allow the pyrotechnic locking device 21 to be housed therein. The body 27 of the pyrotechnic locking device 21 is as described with reference to FIG. 2. The body 27 is supported in the recess 81 by a retaining ring 83, the retaining ring 83 being linked or attached to or formed integrally with several frangible shear links 85 which are themselves attached to or formed integrally with the first structure 25 and which are distributed radially in the recess. The first structure 25 has a channel 87 machined in it for receiving the ignition wires 63 which run between chamber 65 containing the pyrotechnic compound 29 which is located within the body 27 and the electrical power source (not shown). As described with respect to FIG. 2, the body 27 may be provided with a crumple zone 49, or alternatively the crumple zone may be located on the first structure 25 at the base 89 of the recess, or omitted altogether. The pyrotechnic compound may, as described with respect to FIG. 2, be located within the interior of the body or alternatively within an exterior chamber (not shown) which is attached to and travels with the body as the body is ejected from the recess. In this latter case the recess 81 should be shaped to accommodate any such exterior chamber as required. In this example, like in FIG. 2, graduations 75 on the body and corresponding graduations 91 in the recess are provided, but these may be omitted if desired.

FIG. 5 shows the pyrotechnic device of FIG. 4 after it has been activated, and is now in the ‘unlock’ position. The body 27 has fully exited the recess 43 of the second structure 33 and has retracted into the recess 81 of the first structure 25, beyond the interference bore 71. The chamber 69 has a greater diameter than the body 27, and this allows the body to rest out of alignment such that the longitudinal axis of the body 77 does not exactly correspond to the longitudinal axis of the housing 79. The graduation 91 associated with the interference bore 71 acts to prevent the body from protruding from the first structure 25 during subsequent motion of that structure. This ensures that the body 27 cannot re-engage with the second structure 33 once it has been released.

It will be appreciated that the recess 81 of the first structure may be formed by methods other than by machining the structure. For example, drilling and/or other manufacturing techniques may be used, or alternatively the first structure 25 may be formed from two or more portions which are fitted together to define the recess 81.

Similarly, it will be appreciated that although the body 27 has been described as cylindrical in these examples, a body of any suitable cross-sectional shape may be used. In any case, the bore of any housing utilised, the recess 81 in the first structure if used and the recess 43 in the second structure should all be of substantially the same cross-sectional shape as the body 27.

Although the examples refer to the locking in position of a missile fin relative to the body of a missile for launch, it will be recognised that a locking device in accordance with the present invention may be utilised for a variety of purposes, including but not limited to those described in the introductory part of this patent specification.

1. A locking device for maintaining a first and a second member in a fixed relationship, the locking device comprising a body for locating on or within the first member such that, in use, a part of the body protrudes into a recess formed in the second member, a pyrotechnic compound being located on or within the body, means for igniting the pyrotechnic compound, and a channel located in the interior of the body running between the pyrotechnic compound and an exterior surface of the part of the body that, in use, protrudes into the recess formed in the second member.

2. A locking device as claimed in claim 1, wherein a frangible seal is provided where the channel meets the exterior surface of the body to prevent any gas or debris from entering or exiting the channel.

3. A locking device as claimed in claim 2 wherein the frangible seal is designed to fracture when the pressure within the channel reaches a predetermined level.

4. A locking device as claimed in claim 1, wherein the exterior surface of the body comprises one or more graduations.

5. A locking device as claimed in claim 1, wherein the body is provided with a housing, the housing being fixed to a surface of the first member.

6. A locking device as claimed in claim 5 wherein the surface is that surface defining a recess formed in the first member.

7. A locking device as claimed in claim 1, wherein the body is located directly within a recess formed in the first member.

8. A locking device as claimed in claim 1, wherein a crumple zone is provided on or within the body at the end remote from the second member.

9. A locking device as claimed in claim 5, wherein a crumple zone is provided within the housing.

10. A locking device as claimed in claim 7 wherein a crumple zone is provided within the recess formed in the first member.

11. A locking device as claimed in claim 5, wherein the bore of the housing is graduated.

12. A locking device as claimed in claim 7 wherein the bore of the recess formed in the first member is graduated.

13. (canceled)

14. (canceled)

15. A locking device for maintaining a first and a second member in a fixed relationship, the locking device comprising a body located on or within the first member such that a part of the body protrudes into a recess formed in the second member, a pyrotechnic compound being located on or within the body, a pyrotechnic actuator for igniting the pyrotechnic compound, and a channel located in the interior of the body running between the pyrotechnic compound and an exterior surface of the part of the body that protrudes into the recess formed in the second member, wherein ignition of the pyrotechnic compound by the pyrotechnic actuator causes the pyrotechnic compound to generate gas which flows through the channel increasing pressure in the recess so that the body retracts from the recess unlocking the first member from the second member.
